(19) United States
(12) Patent Application Publication
(10) Pub. No.: US 2025/0055142 A1
(43) Pub. Date: Feb. 13, 2025

(54) HIGH TENSILE STRENGTH SEPARATOR

(71) Applicant: BenQ Materials Corporation, Taoyuan (TW)

(72) Inventors: WAN-TING LO, Taoyuan (TW); YI-TING LO, Taoyuan (TW); MENG-CHIA CHENG, Taoyuan (TW)

(73) Assignee: BenQ Materials Corporation, Taoyuan (TW)

(21) Appl. No.: 18/487,097

(22) Filed: Oct. 15, 2023

(30) Foreign Application Priority Data
Aug. 11, 2023 (TW) 112208503

(51) Int. Cl. H01M 50/494; H01M 50/417; H01M 50/446; H01M 50/449; H01M 50/491

(52) U.S. Cl. CPC H01M 50/494; H01M 50/417; H01M 50/446; H01M 50/449; H01M 50/491

(57) ABSTRACT

A high tensile strength separator is disclosed. The separator comprises a porous polyolefin substrate with porous structures on the surface and interior thereof, a strengthening layer formed on at least one surface and the sidewalls of the porous structures of the porous polyolefin substrate, and an inorganic layer comprising a plurality of inorganic particles and a binder and formed on the strengthening layer. The present high tensile strength separator has improved mechanical strength.

### CROSS-REFERENCE TO RELATED APPLICATION

This application claims the benefit of Taiwanese patent application serial No. 112208503, filed on Aug. 11, 2023, the subject matter of which is incorporated herein by reference.

### BACKGROUND OF THE INVENTION

### Field of Invention

This invention relates to a novel separator for lithium battery, and more particularly to a separator for lithium battery with an enhanced mechanical strength.

### Description of Related Art

Lithium battery is composed of four main parts, positive electrode, negative electrode, separator, and electrolyte, wherein the separator is a thin film with a microporous structure, which is mainly used to separate the positive electrode and negative electrode of the battery to prevent the electric short and allow free ions passing through between the electrodes. Therefore, the separator has a decisive influence on the discharge rate, energy density, cycle performance and safety of lithium batteries.

The separator can be mainly manufactured by dry-stretching or wet-stretching. The dry-stretched separator has high safety and low cost, so it is mostly used in large-scale lithium iron phosphate power batteries. The wet-stretched separator can provide better air permeability due to its thin thickness, high porosity and uniform pore size. However, the wet-stretched separator needs to have a coating layer to meet the safety requirements of thermal stability and tensile strength.

When the capacity of the battery is increased, it is generally desired that the separator is thin, so that the ions are easy to pass through and move. In battery assembly and charge-discharge cycle use, the separator itself is expected to have a certain mechanical strength. Since the mechanical strength of the separator may decrease after thinning, it is important to improve the mechanical strength of the separator in order to maintain electrical insulation and ion permeability.

Therefore, the separator still need to have enhanced mechanical strength after thinning to ensure the safety of the battery.

### SUMMARY OF THE INVENTION

The present invention discloses a separator with enhanced tensile strength, comprising a porous polyolefin substrate with porous structures on the surface and interior thereof; a strengthening layer formed on at least one surface and the sidewalls of the porous structures of the porous polyolefin substrate; and an inorganic layer comprising a plurality of inorganic particles and a binder formed on the strengthening layer.

In an embodiment of the present invention, the strengthening layer is a composite layer of hexamethyldisilazane and titanium oxide and/or titanium hydroxide.

In an embodiment of the present invention, the porous polyolefin substrate is a single-layered polyethylene substrate or a single-layered polypropylene substrate.

In an embodiment of the present invention, the thickness of the porous polyolefin substrate is ranging between 5 μm and 30 μm.

In an embodiment of the present invention, the porosity of the porous polyolefin substrate is ranging between 30% and 70%.

In an embodiment of the present invention, the inorganic layer comprises 1 wt % to 20 wt % binder and 80 wt % to 99 wt % inorganic particles. In a preferred embodiment of the present invention, the inorganic layer can be coated on one or both surfaces of the porous polyolefin substrate with the strengthening layer. In a preferred embodiment of the present invention, the thickness of the inorganic layer is ranging between 0.5 μm and 5 μm, and preferably ranging between 0.5 μm and 3 μm.

In an embodiment of the present invention, the inorganic particles of the inorganic layer are Mg(OH)₂, BaSO₄, BaTiO₃, HfO₂, SrTiO₃, SnO₂, CeO₂, MgO, NiO, CaO, ZnO, ZrO₂, SiO₂, Y₂O₃, Al(OH)₃, Al₂O₃, AlOOH, SiC, TiO₂, or combinations thereof. The suitable particle size of the inorganic particles is ranging between 0.1 μm and 3 μm, and preferably ranging between 0.3 μm and 2 μm.

In an embodiment of the present invention, the binder of the inorganic layer is ethylene-vinyl acetate copolymer (EVA), poly(meth)acrylate, crosslinkable (meth)acrylic resin, fluororubber, styrene-butadiene rubber (SBR), polyvinyl alcohol (PVA), polyvinyl butyral (PVB), polyvinylpyrrolidone (PVP), poly-n-vinyl acetamide, polyvinylidene fluoride (PVDF), polyurethane, or combinations thereof.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### BRIEF DESCRIPTION OF THE DRAWINGS

FIG. 1 is a scanning electron microscope (SEM) image of the conventional wet-stretched porous polyolefin substrate used for coating inorganic layers at 40,000 magnifications.

FIG. 2 is a scanning electron microscope (SEM) image of a wet-stretched porous polyolefin substrate with a strengthening layer in an embodiment of the present high tensile strength separator at 40,000 magnifications.

FIG. 3 is a layered schematic diagram of the conventional wet-stretched separator having an inorganic layer.

FIG. 4 is a layered schematic diagram of the present high tensile strength separator.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In the following description, numerous specific details are described in detail in order to enable the reader to fully understand the following examples. However, embodiments of the present invention may be practiced in case no such specific details.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The present invention provides a high tensile strength separator comprising a porous polyolefin substrate with porous structures on the surfaces and interiors thereof; a strengthening layer formed on at least one surface and the sidewalls of the porous structures of the porous polyolefin substrate; and an inorganic layer comprising a plurality of inorganic particles and a binder formed on the strengthening layer.

In the high tensile strength separator of the present invention, the strengthening layer formed on the surface and the sidewalls of the porous structures of the porous polyolefin substrate can increase the mechanical strength of the porous polyolefin substrate, and can enhance the tensile strength, the puncture strength and the compression resistance of the separator without increasing the total thickness thereof. Therefore, the high tensile strength separator of the present invention has higher tensile strength and puncture strength than a separator merely with an inorganic layer of the same thickness.

In an embodiment of the present invention, the strengthening layer is a composite layer of hexamethyldisilazane and titanium oxide and/or titanium hydroxide.

In an embodiment of the present invention, the porous polyolefin substrate is a single-layered polyethylene substrate or a single-layered polypropylene substrate.

In an embodiment of the present invention, the thickness of the porous polyolefin substrate is ranging between 5 μm and 30 μm.

In an embodiment of the present invention, the porosity of the porous polyolefin substrate is ranging between 30% and 70%.

In an embodiment of the present invention, the inorganic layer comprises 1 wt % to 20 wt % binder and 80 wt % to 99 wt % inorganic particles. In a preferred embodiment of the present invention, the inorganic layer can be coated on one or both surfaces of the porous polyolefin substrate with the strengthening layer. In a preferred embodiment of the present invention, the thickness of the inorganic layer is ranging between 0.5 μm and 5 μm, and preferably ranging between 0.5 μm and 3 μm.

In an embodiment of the present invention, the inorganic particles of the inorganic layer are Mg(OH)₂, BaSO₄, BaTiO₃, HfO₂, SrTiO₃, SnO₂, CeO₂, MgO, NiO, CaO, ZnO, ZrO₂, SiO₂, Y₂O₃, Al(OH)₃, Al₂O₃, AlOOH, SiC, TiO₂, or combinations thereof. The suitable particle size of the inorganic particles is ranging between 0.1 μm and 3 μm, and preferably ranging between 0.3 μm and 2 μm.

In an embodiment of the present invention, the binder of the inorganic layer is ethylene-vinyl acetate copolymer (EVA), poly(meth)acrylate, crosslinkable (meth)acrylic resin, fluororubber, styrene-butadiene rubber (SBR), polyvinyl alcohol (PVA), polyvinyl butyral (PVB), polyvinylpyrrolidone (PVP), poly-n-vinyl acetamide, polyvinylidene fluoride (PVDF), polyurethane, or combinations thereof.

In an embodiment of the present invention, the strengthening layer can be formed on the surface and the sidewalls of the porous structures of the porous polyolefin substrate by sequentially applying a titanium alkoxide solution of 0.1 wt % to 5 wt %, a hexamethyldisilazane of 0.1 wt % to 5 wt % and a 30 wt % to 70 wt % alcohol solution to the porous polyolefin substrate.

In an embodiment of the present invention, the titanium alkoxide solution for forming the strengthening layer is titanium methoxide solution, titanium ethoxide solution, titanium isopropoxide solution, titanium tert-butoxide solution or combinations thereof, and preferably is titanium isopropoxide solution, and the solvent of the titanium alkoxide solution is methanol, ethanol, isopropanol or combinations thereof.

In an embodiment of the present invention, the alcohol solution for forming the strengthening layer is methanol solution, ethanol solution, isopropanol solution, ethoxyethanol solution, allyl alcohol solution, ethylene glycol solution or combinations thereof. In a preferred embodiment of the present invention, the alcohol solution for forming the strengthening layer is methanol solution, ethanol solution, isopropanol solution or combinations thereof. In a preferred embodiment of the present invention, the alcohol solution is an 40 wt % to 60 wt % alcohol solution.

In an embodiment of the present invention, the strengthening layer further comprises additives such as tackifiers, antistatic agents, flame retardants, antioxidants, or surface modifiers as required.

In an example of an embodiment of the present invention, a polyethylene porous substrate with a thickness of 9 μm (porosity 48%) was immersed in the titanium isopropoxide solution prepared by mixing 196.4 g of anhydrous alcohol (purity 99.5%), 1.6 g of titanium isopropoxide (TTIP) and 2 g of hexamethyldisilazane for 1 minute, and then residual solution on the surface was removed by a blade, and then the polyethylene porous substrate was immersed in the ethanol solution prepared by mixing 98.4 g of deionized water, 98.4 g of ethanol (purity 95%), 3 g of poly-N-vinylacetamide (PNVA GE191-107) and 0.13 g of polyacrylate (BM-950B). The porous polyethylene substrate was taken out and dried at 80° C. to form a strengthening layer on the surface and the sidewalls of the porous structures of the porous polyethylene substrate. After that, an inorganic particles coating solution prepared by mixing 38 g of Al₂O₃ particles (CQ-030EN, available from Shandong Sinocera Functional Materials Co., Ltd., CN), 3.4 g of polyacrylate, 0.68 g of ammonium polyacrylate (BYK-154, solid content 42%, available from BYK, Germany), 0.13 g of polyether-modified silicone surfactant (BYK-349, available from BYK, Germany) and 52.9 g of deionized water, was coated to the obtained porous polyethylene substrate with the strengthening layer, and dried to form an inorganic layer with a thickness of 2 μm on both opposite surfaces of the porous polyethylene substrate with the strengthening layer to obtain a high tensile strength separator with a total thickness of 13 μm.

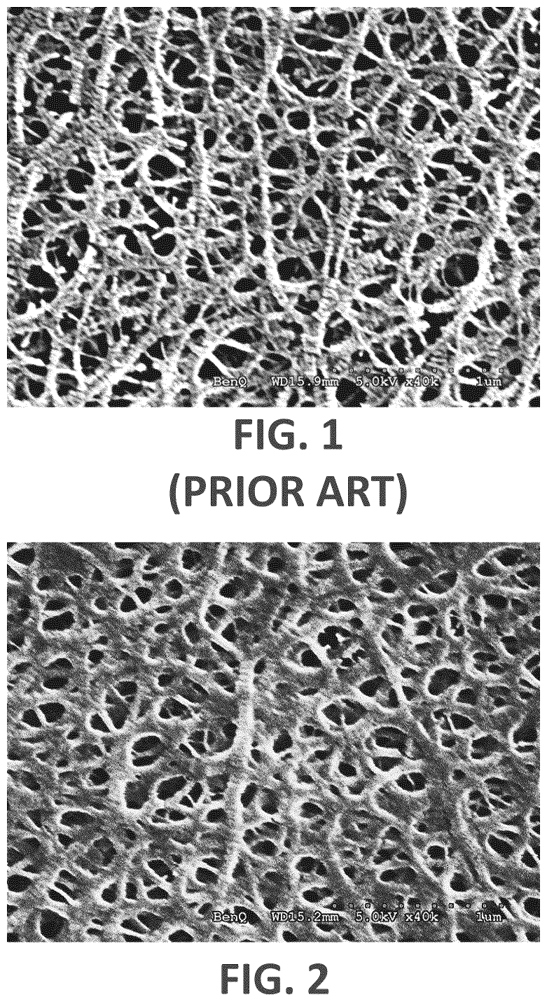

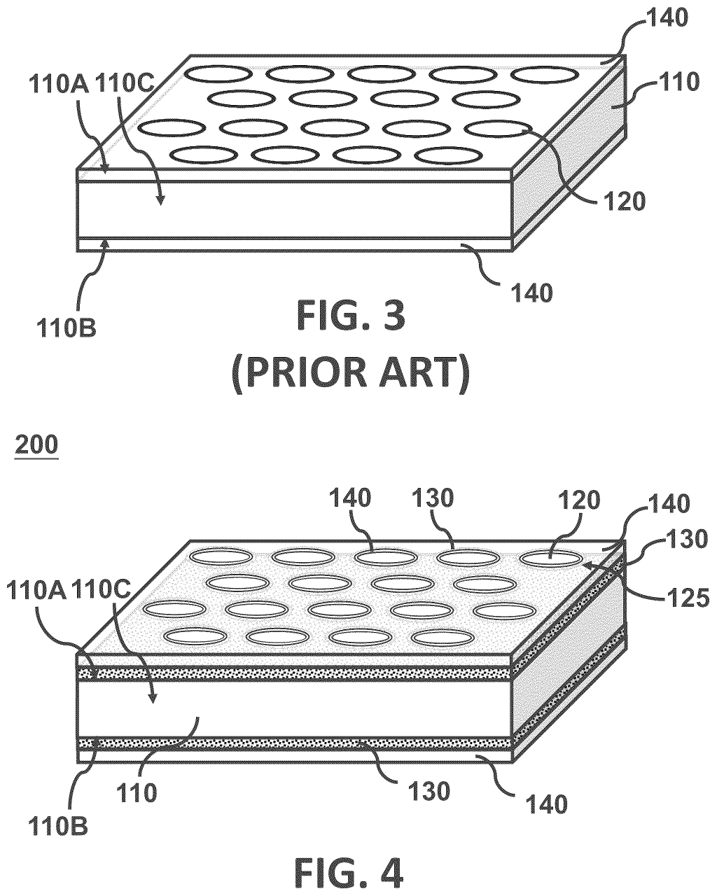

FIG. 1 is a scanning electron microscope (SEM) image of the conventional wet-stretched porous polyolefin substrate used for coating inorganic layers at 40,000 magnifications. FIG. 3 is a layered schematic diagram of the conventional wet-stretched separator 100. The conventional wet-stretched separator 100 comprises a porous polyolefin substrate 110 and inorganic layers 140 formed on the surfaces 110A and 110B of the porous polyolefin substrate 110, wherein the surfaces 110A and 110B and the interior 110C of the porous polyolefin substrate 110 have a plurality of porous structures 120, and the inorganic layers 140 comprise a plurality of inorganic particles (not shown) and a binder (not shown). FIG. 2 is a scanning electron microscope (SEM) image of a wet-stretched porous polyolefin substrate with a strengthening layer in an embodiment of the present high tensile strength separator at 40,000 magnifications. FIG. 4 is a layered schematic diagram of the present high tensile strength separator 200. The high tensile strength separator 200 comprises a porous polyolefin substrate 110, a strengthening layer 130 and inorganic layers 140, wherein the surfaces 110A and 110B and the interior 110C of the porous polyolefin substrate 110 have a plurality of porous structures 120, and the strengthening layer 130 is formed on the surface 110A and 110B and the sidewalls 125 of the porous structures 120 of porous polyolefin substrate 110, and the inorganic layers 140 is formed on the strengthening layer 140 comprising a plurality of inorganic particles (not shown) and a binder (not shown). Compared with the conventional wet-stretched separator 100, the strengthening layer 130 of the high tensile strength separator 200 can increase the thickness of the sidewalls 125 of the porous structure 120, and can increase the mechanical strength of the porous polyolefin substrate 110, therefore the tensile strength, the puncture strength and the compression resistance of the high tensile strength separator 200 can be enhanced without increasing the total thickness thereof. In an embodiment, taking the separator formed by the porous polyolefin substrate with a thickness of 9 μm and coated with the inorganic layers of 2 μm on both sides as an example, both tensile strength in machine direction (MD) and transverse direction (TD) of the separator without having a strengthening layer are less than 1400 Kgf/cm², and the puncture strength thereof is less than 400 gf, while the tensile strength in both machine direction (MD) and transverse direction (TD) of the present high tensile strength separator with strengthening layers are enhanced to greater than 1450 Kgf/cm², preferably greater than 1500 Kgf/cm², and the puncture strength thereof is greater than 400 gf, preferably greater than 430 gf.

Moreover, the compression resistance of the present high tensile strength separator with strengthening layers is greater than 90% after being compressed with a load of 88 Kgf/cm² for 30 seconds, which can inhibit the deformation of the pores of the separator and maintain the ionic conductivity in the thickness direction of the separator. And because the pores of the separator are not excessively deformed due to stress after compression, a certain air permeability can still be maintained, that is, the decreasing rate of air permeability (Gurley) after being compressed of the separator is less than 40%, and thereby the increase of the internal resistance or internal pressure of the battery caused by the stress generated during use can be avoided.

The “compression resistance” herein is calculated from the initial thickness (T1) of the separator and the compressed thickness (T2) measured after being compressed with a load of 88 Kgf/cm² for 30 seconds according to the following formulas:

Compression rate (%)=(T1−T2)/T1×100

Compression resistance=100%−Compression rate (%)

The “decreasing rate of air permeability (Gurley, sec/100 c.c.) after being compressed” means that the structure of the separator is damaged after being compressed with a load of 88 Kgf/cm² for 30 seconds, and results in the decreasing rate of air permeability. The decreasing rate is calculated from the Gurley number before being compressed (G1) and Gurley number after being compressed with a load of 88 Kgf/cm² for 30 seconds (G2) according to the formula:

Decreasing rate of air permeability after being compressed (%)=(1−G1/G2)×100%

The tensile strength herein was tested according to ASTM D882-09. The separator was cut along the machine direction (MD) and the transverse direction (TD) to obtain a sample with a width of 10 mm and a length ≥150 mm. The obtained sample was tested by utilizing a universal tensile machine to stretch at a rate of 500 mm/min to obtain the maximum load during the broken of the sample. The mechanical strength in the machine direction (MD) and the mechanical strength in the transverse direction (TD) were respectively calculated by dividing the maximum load with the cross-sectional area of the separator (width of the sample×the thickness of the substrate).

The puncture strength (gf) was measured by a tensile tester (MSG-5, available from Kato Tech, Japan). The separators were punctured by a round head stainless steel needle with a diameter of 1 mm and a corner radius of 0.5 mm with at a speed of 100±10 mm/min. The maximum force (gf) for puncturing the separator was recorded.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. A high tensile strength separator, comprising:
a porous polyolefin substrate with a plurality of porous structures on surfaces and interiors thereof;
a strengthening layer formed on at least one surface and sidewalls of the porous structures of porous polyolefin substrate; and
an inorganic layer comprising a plurality of inorganic particles and a binder formed on the strengthening layer.

2. The high tensile strength separator as claimed in claim 1, wherein the strengthening layer is a composite layer of hexamethyldisilazane and titanium oxide and/or titanium hydroxide.

3. The high tensile strength separator as claimed in claim 1, wherein the porous polyolefin substrate is a single-layered polyethylene substrate or a single-layered polypropylene substrate.

4. The high tensile strength separator as claimed in claim 1, wherein the thickness of the porous polyolefin substrate is ranging between 5 μm and 30 μm.

5. The high tensile strength separator as claimed in claim 1, wherein the porosity of the porous polyolefin substrate is ranging between 30% and 70%.

6. The high tensile strength separator as claimed in claim 1, wherein the inorganic layer comprises 1 wt % to 20 wt % binder and 80 wt % to 99 wt % inorganic particles, and the thickness of the inorganic layer is ranging between 0.5 μm and 3 μm.

7. The high tensile strength separator as claimed in claim 6, wherein the inorganic particles of the inorganic layer are Mg(OH)₂, BaSO₄, BaTiO₃, HfO₂, SrTiO₃, SnO₂, CeO₂, MgO, NiO, CaO, ZnO, ZrO₂, SiO₂, Y₂O₃, Al(OH)₃, Al₂O₃, AlOOH, SiC, TiO₂, or combinations thereof, and the particle size of the inorganic particles is ranging between 0.1 μm and 3 μm.

8. The high tensile strength separator as claimed in claim 7, wherein the binder of the inorganic layer is ethylene-vinyl acetate copolymer (EVA), poly(meth)acrylate, crosslinkable (meth)acrylic resin, fluororubber, styrene-butadiene rubber (SBR), polyvinyl alcohol (PVA), polyvinyl butyral (PVB), polyvinylpyrrolidone (PVP), poly-n-vinyl acetamide, polyvinylidene fluoride (PVDF), polyurethane, or combinations thereof.
